(19) United States
(12) Patent Application Publication
(10) Pub. No.: US 2022/0067854 A1
(43) Pub. Date: Mar. 3, 2022

(54) TOUR OPERATIONS AND TRAVEL MANAGEMENT PLATFORM

(71) Applicant: Partiture Orchestrated logistics LLC, Tbilisi (GE)

(72) Inventor: Saba Kiknadze, Tbilisi (GE)

(73) Assignee: Partiture Orchestrated logistics LLC, Tbilisi (GE)

(21) Appl. No.: 17/008,315

(22) Filed: Aug. 31, 2020

(51) Int. Cl. G06Q 50/14; G06T 11/60; G06Q 10/10; G06Q 30/02; G06Q 10/02

(52) U.S. Cl. CPC G06Q 50/14; G06T 11/60; G06Q 10/10; G06N 20/00; G06Q 10/025; G06T 2200/24; G06Q 30/0205

(57) ABSTRACT

Embodiments generally relate to tour operations and travel management. In some implementations, a method includes generating one or more tour forming components, where the one or more tour forming components include one or more of a transportation component, an accommodation component, a catering component, a supply component, a sightseeing component, an activities component, a services component, and an events component. The method further includes generating one or more itineraries for one or more travelers, where each itinerary of the one or more itineraries is based on at least the one or more tour forming components.

### TECHNICAL FIELD

The described embodiments relate generally to tourism and travel, and more specifically to a system for tour operations and travel management.

### BACKGROUND

A tour operator provides tour packages that involve tour and travel aspects. Such tour and travel aspects may include, for example, itineraries, accommodation, catering, transportation, guides, services, tour leaders, etc., which enable tourists to better enjoy their vacations without needing to organize these tour and travel aspects. Designing and executing these tour packages is difficult due to the inherent complexity of logistics and costs involved with airfare, hotels, and numerous various services that are involved on tours.

### SUMMARY

Embodiments generally relate to a tour operations and travel management platform. In some implementations, a system includes one or more processors, and includes logic encoded in one or more non-transitory computer-readable storage media for execution by the one or more processors. When executed, the logic is operable to cause the one or more processors to perform operations including: generating one or more tour forming components, where the one or more tour forming components include one or more of a transportation component, an accommodation component, a catering component, a supply component, a sightseeing component, an activities component, a services component, and an events component; and generating one or more itineraries for one or more travelers, where each itinerary of the one or more itineraries is based on at least the one or more tour forming components.

In some implementations, a system includes one or more processors, and includes logic encoded in one or more non-transitory computer-readable storage media for execution by the one or more processors. When executed, the logic is operable to cause the one or more processors to perform operations including: generating one or more itineraries for one or more travelers, where each itinerary of the one or more itineraries is associated with one or more tour forming components; determining one or more tour forming component timelines associated with the one or more tour forming components; determining one or more master timelines based on at least the one or more tour forming component timelines; modifying at least one master timeline of the one or more master timelines to provide at least one modified master timeline based on one or more policies, where at least one policy of the one or more policies is based on at least one characteristic of the one or more travelers; and generating at least one modified itinerary for the one or more travelers, where the at least one modified itinerary is based on the at least one modified master timeline.

In some embodiments, a non-transitory computer-readable storage medium with program instructions thereon is provided. When executed by one or more processors, the instructions are operable to cause the one or more processors to perform operations including: generating one or more itineraries for one or more travelers, where each itinerary of the one or more itineraries is associated with one or more tour forming components; determining one or more tour forming component timelines associated with the one or more tour forming components; determining one or more master timelines based on at least the one or more tour forming component timelines; modifying at least one master timeline of the one or more master timelines to provide at least one modified master timeline based on one or more policies, where at least one policy of the one or more policies is based on at least one characteristic of the one or more travelers; and generating at least one modified itinerary for the one or more travelers, where the at least one modified itinerary is based on the at least one modified master timeline.

A further understanding of the nature and the advantages of particular implementations disclosed herein may be realized by reference of the remaining portions of the specification and the attached drawings.

### BRIEF DESCRIPTION OF THE DRAWINGS

FIG. 1 is a block diagram of an example tour building network environment for implementing a tour operations and travel management platform, which may be used for embodiments described herein.

FIG. 2 is an example flow diagram for providing a tour operations and travel management platform, according to some embodiments.

FIG. 3 is an example flow diagram involving tour forming components and associated itineraries and timelines, according to some embodiments.

FIG. 4 is an example flow diagram for providing a tour operations and travel management platform, according to some embodiments.

FIG. 5 is a screen shot showing example tour forming components, according to some embodiments.

FIG. 6 is a screen shot showing example tour master timeline, according to some embodiments.

FIG. 7 is a screen shot showing example transport timelines, according to some embodiments.

FIG. 8 is a screen shot showing example master timelines, according to some embodiments.

FIG. 9 is a block diagram of an example computer system, which may be used for some embodiments described herein.

### DETAILED DESCRIPTION

Embodiments described herein provide a tour operations and travel management platform. The tour operations and travel management platform may also be referred to as a tour builder platform or tour builder system. As described in more detail herein, the tour builder system is flexible, customizable, and provides a wizard-supported working process. In various embodiments, the tour builder system tracks all actions according one or more workflow processes.

Tour operators are challenged by an inherent complexity of tour and travel logistics, which include various different components. Such components may include, for example, accommodation, transportation, catering, excursions, events, involved human recourses management and other service-related issues. As described in more detail herein, the tour builder system facilitates planning, designing, pricing, operating, supervising, reporting, etc. of each component separately, as well facilitates overall management of a tour and associated components in a sequenced and orchestrated way. In various embodiments, a tour building system generates itineraries with accurate timelines that reflect accurate time frames of different events and accurate transition times between the different events. The tour building system computes and adjusts these time frames and transition times based on characteristics of the group traveling or tour group. This results in time savings, cost savings, and overall optimization of tour and travel logistics. Various embodiments associated with these features are described in more detailed herein.

The tour builder system may be implemented (embedded or used) by small to large travel and tourism companies that design and conduct inbound and outbound land operations for clients ranging from individuals and group travelers to corporations. The tour builder system is based on a travel business algorithm for standard international travel and tourism operations. These operations may include, for example, marketing, booking, sales, and operations within and between different industry representatives. Such industry representatives may include, for example, agents, destination management companies, tour operators, domestic land operators, and other suppliers to the travel and tourism industry.

In various embodiments, a system generates one or more tour forming components. These tour forming components may include one or more of a transportation component, an accommodation component, a catering component, a supply component, a sightseeing component, an activities component, a services component, and an events component. In various embodiments, the system generates one or more itineraries for one or more travelers, where each of the itineraries is based on one or more of the tour forming components.

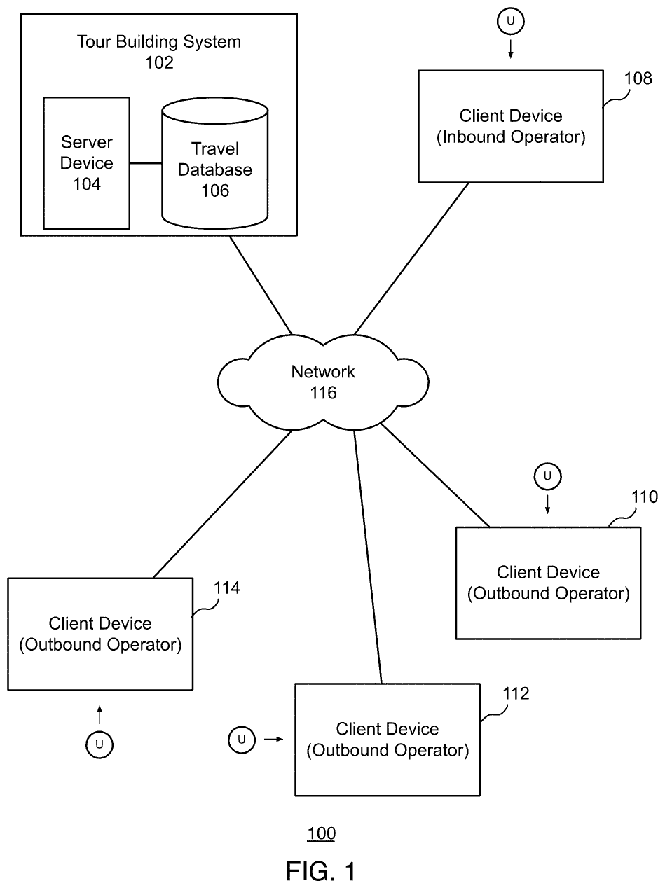

FIG. 1 is a block diagram of an example tour building network environment 100 for implementing a tour operations and travel management platform, which may be used for embodiments described herein. In some implementations, tour building network environment 100, or network environment 100, includes a tour building system 102, or system 102, which includes a server device 104 and a travel database 106. The terms tour building system 102, system 102, and the system may be used interchangeably.

In various embodiments, tour building system 102 includes three main functional blocks with fully controllable systems of data input and output. In various embodiments, server device 104 and a travel database 106 of tour building system 102 perform these main function blocks. For example, server device 104 performs operational and processing block functionalities involving travel database 106 and ongoing projects and completed projects. Server device 104 also performs smart optimization block functionalities involving travel database 106 and ongoing projects and completed projects. In various embodiments, travel database 106 performs database block functionalities.

In various embodiments, the smart optimization block functionalities performed by server device 104 includes machine learning functionalities. Tour building system 102 also synchronizes global positioning system (GPS) generated data with ongoing and past tours parameters, characteristics, and logistics. In various embodiments, tour building system 102 enables corrections in planning processes and future operations. This results in time savings, cost savings, and optimization of logistics.

In various embodiments, tour building system 102 determines transition time periods between tour phases. Tour building system 102 continuously reevaluates the transition time periods to enable improved planning and operational decisions for tour delivery. Transition time periods are described in more detail herein.

In various embodiments, tour building system 102 considers various tour parameters with itineraries and timelines for optimal product offers. For example, such tour parameters may include: characteristics of travelers' groups or individuals' (age, gender, cultural, ethnical, travel experience, scope of interest, etc.), tour types (cultural, experiential, exploratory, adventurous, business, family, etc.), level of services and budget (Luxury, Standard, Economy, Youth, etc.), nationality and religious preferences, if any; dietary requirements; special security and/or other specific needs.

In some embodiments, travel database 106 stores information on corporate and individual customers. Travel database 106 also stores tour components details, including when needed ports for access to various internet-based global distribution systems for air bookings, hotel bookings, and other inventory.

Network environment 100 also includes client devices 108, 110, 112, and 114, which may communicate with system 102 and/or may communicate with each other directly or via system 102. Client devices 108, 110, 112, and 114 may be associated with respective inbound and/or outbound tour operators and are configured to interact with users. Network environment 100 also includes a network 116 through which system 102 and client devices 108, 110, 112, and 114 communicate. Network 116 may be any suitable communication network such as a Wi-Fi network, Bluetooth network, the Internet, etc.

In this example embodiment, client device 108 may be associated with an inbound operator. Also, client devices 110, 112, and 114 are associated with outbound operators. Inbound tour operators typically provide local tour packages to tourists or tour groups, which typically include travelers from other destinations (e.g., another country, etc.) Inbound tour operators facilitate international travel, where language or communication is involved. Conversely, outbound tour operators typically collaborate with inbound tour operators to provide such tour packages to tourists or tour groups.

For ease of illustration, FIG. 1 shows one block for each of system 102, server device 104, and travel database 106, and shows four blocks for client devices 108, 110, 112, and 114. Blocks 102, 104, and 106 may represent multiple tour building systems, server devices, and travel databases. Also, there may be any number of client devices. In other implementations, environment 100 may not have all of the components shown and/or may have other elements including other types of elements instead of, or in addition to, those shown herein.

While system 102 performs embodiments described herein, in other embodiments, any suitable component or combination of components associated with system 102 or any suitable processor or processors associated with system 102 may facilitate performing the embodiments described herein.

In the various embodiments described herein, a processor of system 102 and/or a processor of any client device 108, 110, 112, and 114 cause the elements described herein (e.g., travel information such as tour forming components, itineraries, timelines, etc.) to be displayed in a user interface on one or more display screens.

In the various embodiments, tour building system 102 provides wizard-supported workflow processes, and stores all actions according such workflow processes. Tour building system 102 also generates timelines associated with each of the tour forming components. Tour building system 102 also manages the timelines in the manner, the master timeline for coordination and control of an entire project.

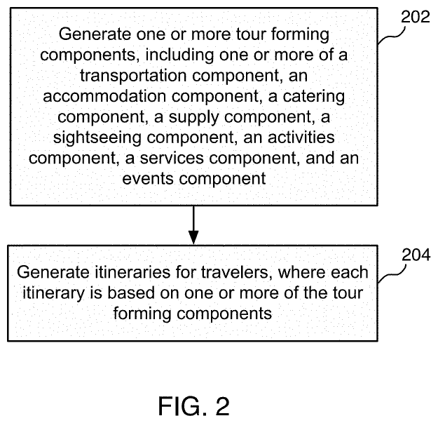

FIG. 2 is an example flow diagram for providing a tour operations and travel management platform, according to some embodiments. Referring to both FIGS. 1 and 2, a method is initiated at block 202, where a system such as tour building system 102, or system 102, generates one or more tour forming components.

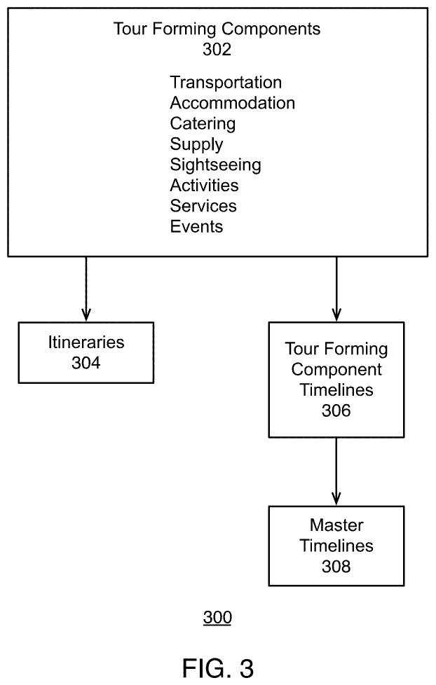

In various embodiments, the one or more tour forming components include one or more of a transportation component, an accommodation component, a catering component, a supply component, a sightseeing component, an activities component, a services component, and an events component. Embodiments directed to tour forming components and associated itineraries and timelines are described in more detail herein, in connection with FIG. 3 for example.

At block 204, the system generates one or more itineraries for one or more travelers. In various embodiments, each of the itineraries is based on at least the one or more tour forming components.

Although the steps, operations, or computations described herein may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

FIG. 3 is an example flow diagram involving tour forming components and associated itineraries and timelines, according to some embodiments. As shown, tour forming components 302 may include transportation, accommodation, catering, supply, sightseeing, activities, services, events, etc. The particular tour forming components may vary and depend on the particular implementation. Tour building system 102 generates itineraries 304, tour forming component timelines 306, and master timelines 308 based on tour forming components 302.

In various embodiments, the system determines one or more tour forming component timelines based on at least the one or more travelers. The tour builder system also provides timelines for each tour forming component. The system then modifies at least one of the tour forming component timelines based on one or more policies, which are described in more detail herein.

Tour forming component timelines are designed according each component, having their specific timeline phases, guarantying continuous control, efficient management, coordination and synchronization with other management processes and overall workflow.

In various embodiments, the system determines tour phases associated with each of the tour forming components. The system then determines transition time periods between the tour phases. The system then modifies at least one of the transition time periods based on one or more policies.

In various embodiments, the system determines one or more tour forming component cost values associated with the one or more tour forming components. The system then modifies at least one of the tour forming component cost values based on one or more policies.

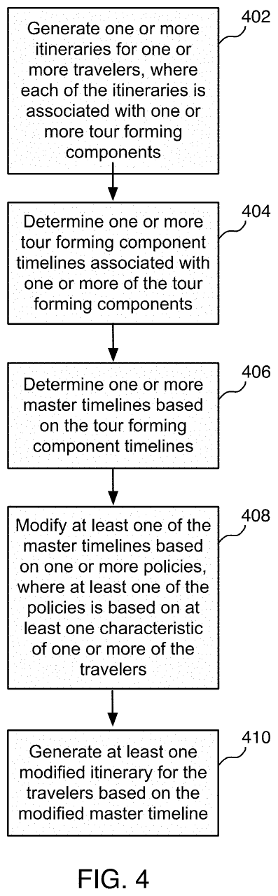

FIG. 4 is an example flow diagram for providing a tour operations and travel management platform, according to some embodiments. Referring to both FIGS. 1 and 4, a method is initiated at block 402, where a system such as system 102 generates one or more itineraries for one or more travelers. In various embodiments, each of the itineraries is associated with one or more tour forming components.

In various embodiments, the one or more travelers are associated with a group of travelers. In various embodiments, the system may categorize a given group travelers as a type of group of travelers. For example, the system may categorize a given travelers as a group of travelers from a particular country (e.g., United States, Germany, Japan, etc.). In another example, the system may categorize a given travelers as a group of travelers of a particular age range (e.g., high school students, elderly, etc.). The particular category or type of group may vary, and will depend on the particular embodiment. For example, in another example, the system may categorize a given travelers as a group of travelers of a particular interest (e.g., general sightseeing, sightseeing of historical building and monuments, hiking, adventure, etc.).

In various embodiments, the one or more travelers are individual travelers. In various embodiments, the system may categorize each individual as one of a particular individual type of individual category. For example, the system may categorize a given traveler as a traveler from a particular country (e.g., United States, Germany, Japan, etc.). In another example, the system may categorize a given traveler as a traveler of a particular age range (e.g., high school students, elderly, etc.). The particular category or type of group may vary, and will depend on the particular embodiment. For example, in another example, the system may categorize a given travelers of a particular interest (e.g., general sightseeing, sightseeing of historical building and monuments, hiking, adventure, etc.).

In various embodiments, the one or more travelers are subjects of one or more of a land operation, a domestic tour, an inbound tour, and an outbound tour. In various embodiments, the system may categorize a given traveler or given group of travelers as a traveler or travelers who are subjects of these and/or other types.

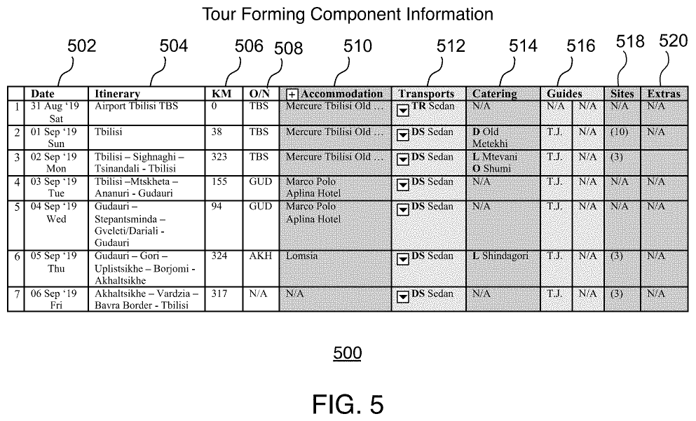

In various embodiments, the one or more tour forming components are associated with local services at a destination location. For example, local services may include transportation services, accommodation services, etc. In various embodiments, the one or more tour forming components may include one or more of a transportation component, an accommodation component, a catering component, a supply component, a sightseeing component, an activities component, a services component, and an events component. Embodiments directed to tour forming components are described in more detail herein, in connection with FIG. 5 for example.

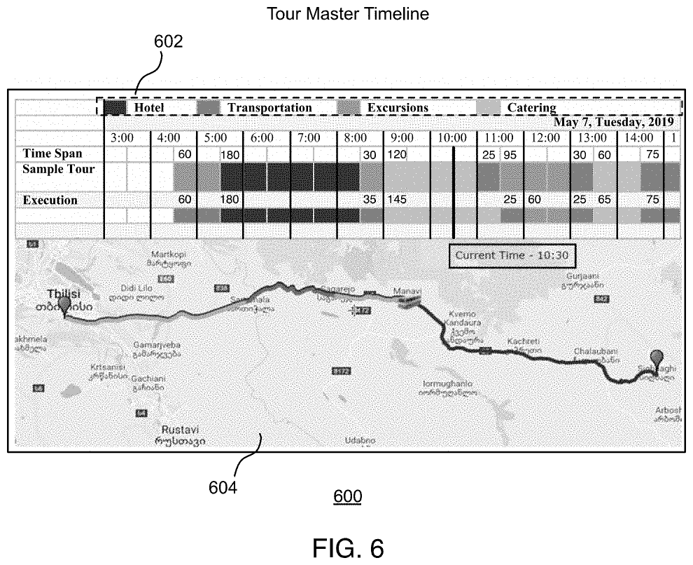

At block 404, the system determines one or more tour forming component timelines associated with one or more tour forming components. Embodiments directed to tour forming component timelines are described in more detail herein, in connection with FIG. 6 for example.

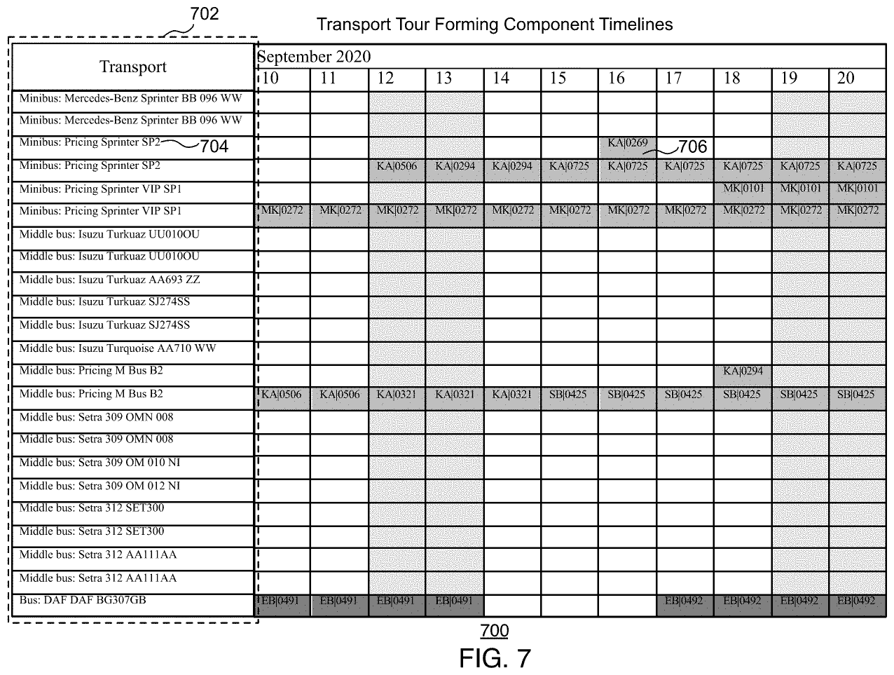

At block 406, the system determines one or more master timelines based on at least the one or more tour forming component timelines. Embodiments directed to master timelines are described in more detail herein, in connection with FIG. 7 for example.

At block 408, the system modifies at least one master timeline of the one or more master timelines to provide at least one modified master timeline based on one or more policies. In various embodiments, at least one policy of the one or more policies is based on at least one characteristic of the one or more travelers.

At block 410, the system generates at least one modified itinerary for the one or more travelers. In various embodiments, the modified itinerary is based on the at least the one modified master timeline.

FIG. 5 is a screen shot 500 showing example tour forming components, according to some embodiments. Shown is a column 502 showing dates (e.g., 1 Sep. 1919, etc.), a column 504 showing an associated itinerary (e.g., Tbilisi, etc.), a column 506 showing a distance (e.g., 38 kilometers, etc.) between an originating country and location from with the user traveled such as Tbilisi (TBS) to the destination TBS, a column 508 (labeled O/N) showing the origination country (e.g., TBS), a column 510 showing of accommodations (e.g., Mercure Tbilisi Old . . . , etc.), a column 512 showing transportation (labeled “Transports”) information (e.g., DS Sedan, etc.), a column 514 showing catering information (e.g., D Old Metekhi, etc.), a column 516 showing guide information (e.g., T.J., etc.), a column 518 showing site information (e.g., “(10)” sites which may be a site count, etc.), and a column 520 showing any extra information as applicable.

FIG. 6 is a screen shot 600 showing an example tour master timeline, according to some embodiments. Shown is a legend 602 indicating a tour master timeline for one tour group. The terms tour master timeline and master timeline may be used interchangeably. In various embodiments, the tour master timeline is based on and may include components from tour forming component timelines, such as hotel-related tour forming component timelines, transportation-related tour forming component timelines, excursion-related tour forming component timelines, catering-related tour forming component timelines, etc. The system may also provide a map 604 that corresponds to that particular tour. In some embodiments, the system may generate a tour master timeline with different events at different times. For example, the system may schedule an excursion scheduled for 4:30 a.m.-5:30 a.m., followed by hotel time scheduled for 5:30 a.m.-7:30 a.m., followed by transportation scheduled for 8:30 a.m.-9:00 a.m., followed by catering scheduled for 9:00 a.m.-11:00 a.m., etc.

FIG. 7 is a screen shot 700 showing example transport tour forming component timelines, according to some embodiments. Shown is a transport vehicle list 702. Transport vehicle list 702 may include a variety of transport vehicle types (e.g., minibuses, buses, etc.), as well as vehicle makes and models. The particular transport vehicle may vary, depending on the particular implementation. For example, transport vehicles may also include vehicles in categories such as sedans, four-wheel drives, vans, middle buses, minivans, etc. Also shown to the right of some transport vehicles are scheduled dates for particular tour groups. For example, a transport vehicle 704 may be scheduled for September 16 to transport tour group 706 (also labeled KA|0269). In some embodiments, moving a cursor over a data box, e.g. 706, may display a popup window with additional information.

As indicated above, the system may modify one of the tour forming component timelines based on one or more policies, including any associated tour timelines. In various embodiments, tours associated with itineraries are monitored in real-time. In some embodiments, the system may determine that the actual time duration or time frame was different from an expected time frame and would thus learn the difference in a timeline. For example, the system may determine that a catering event lasted 5 minutes longer than an expected time frame in the touring form component timeline. As such, the system may adjust the time frame accordingly. For example, in some embodiments, a policy may be to adjust the expected time frame in the touring form component timeline to conform to the actual time frame (e.g., increasing the time frame by 5 minutes). Conversely, in another example, if the actual time frame were less than the expected time frame, the system may decrease the expected time frame in the touring form component timeline. As such, the updated time frame in the touring form component timeline would better predict a future actual time frame. In some embodiments, a policy may be to compute an average time frame based on previous actual time frames if actual time frames vary. In some embodiments, one or more policies may be for the system to tailor the expected time frame based on a variety of factors. Such factors may include the type of tour group, the region, the season, etc. As such, in various embodiments, the system may adjust one or more itineraries based on a variety of factors associated a traveler or group of travelers. For example, in some embodiments, if the season is winter, the region is mountainous, and/or the tour group is filled with elderly people, a policy may be to increase the time frame for the transportation component master timeline. The particular factors may vary and depend on the particular implementation.

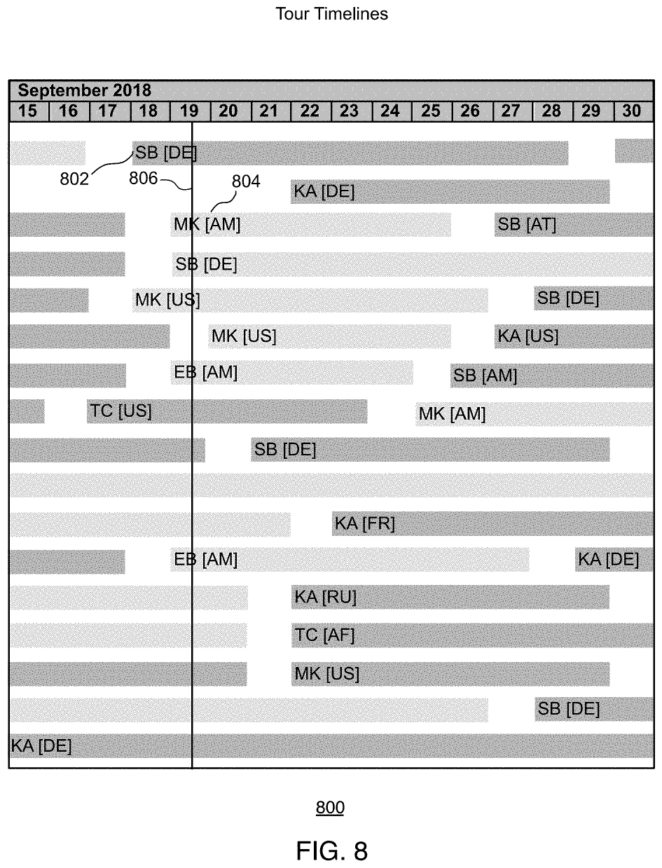

FIG. 8 is a screen shot 800 showing example tour timelines for multiple tours, according to some embodiments. As shown, the tour timelines include timeline 802 and timeline 804 among other timelines.

Also shown, in various embodiments, the system automatically moves line or bar indicator 806 to the right over time. In this particular example, the position of bar indicator 806 is based on the current calendar data. Given all of the master timelines, the moving bar indicator 806 overlap with various different master timelines, e.g., the master timeline 802 and master timeline 804 in the example illustrated in FIG. 8. The tour builder system manages the tour forming component timelines for each tour group in master project timelines for coordination and control of entire projects.

In some embodiments, with regard to the master timelines or main timelines, in addition to functioning mainly as a workflow control processor, the system unites sequenced tour component timelines and makes then synchronized and interactive. In various embodiments, the main project timeline includes a tour operation timeline that controls various tour processes from start to end. The tour operation timeline manages tours in order to meet various planned tour schedule, meet customer expectations, as well as security and safety criteria.

In various embodiments, the tour operation timeline includes various continuous and shifting actions of the tour. Such actions may include, for example, time segments for transportation, accommodation, catering, sightseeing/activity, free time.

As indicated herein, in various embodiments, tour building system 102 determines transition time periods between tour phases. These transition time periods are time periods between tour phases (e.g., main time segments). Transition time periods provide time markers for chronological analyses of different actions of a tour. In various embodiments, tour building system 102 continuously or periodically reevaluates the transition time periods to enable improved planning and operational decisions for tour delivery. As indicated above, the system modifies one of the tour forming component timelines based on one or more policies

In various embodiments, the system may be used in implementing 4 main phases associated with tour building. For example, in a Phase 1, the system may provide design and proposal features. For example, in various embodiments, the system may provide a user interface for organizing an itinerary. In some embodiments, the system receives tour design and itinerary information from user of an agency/operator who designs and builds an itinerary for a client. In some embodiments, the itinerary may include content of the tour, pricing, client communication, proposal to the client, adjustments in coordination with the client, etc.

In a Phase 2, the system may provide tour preparation features. For example, in various embodiments, the system may provide a user interface for receive booking and/or preparation information associated with tour components such as transportation, accommodation, catering, supply, sightseeing, activities, services, events, etc.

In a Phase 3, the system may provide tour operation features. For example, in various embodiments, the system may provide a user interface for monitoring and managing various actions and/or activities of the tour from arrival to departure using GPS generated data.

In a Phase 4, the system may provide post-tour report and financial features. For example, in various embodiments, the system may provide a user interface for enabling the generation and database storage of various types of user feedback (e.g., feedback from customer, staff, suppliers, etc.), statistical and marketing reports, financial statements, the automatic transfer to dedicated accounting program of all related financial documents, and statements complying with international financial reporting standards. Such financial documents and statements may include, for example, income statements, account payable statements, invoices, bills, wages, and other expense data.

In various embodiments, at least one policy of the one or more policies is based on at least one characteristic of one or more of the tour forming components. In various embodiments, the system causes a user interface to display the one or more tour forming component timelines. In various embodiments, the system determines a tour forming component cost value associated with at least one tour forming component.

Although the steps, operations, or computations described herein may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

Implementations described herein provide various benefits. For example, the tour builder system is suited for unique needs of a particular user, and provides a practical solution and user-friendly interface for users in travel companies. Embodiments provide itineraries with accurate timelines. Embodiments enable users to view an entire process from specific points of view. Such users may include top management, agent, tour managers, reservationists, logistics, security, supervision, marketing, financial, and/or other duties.

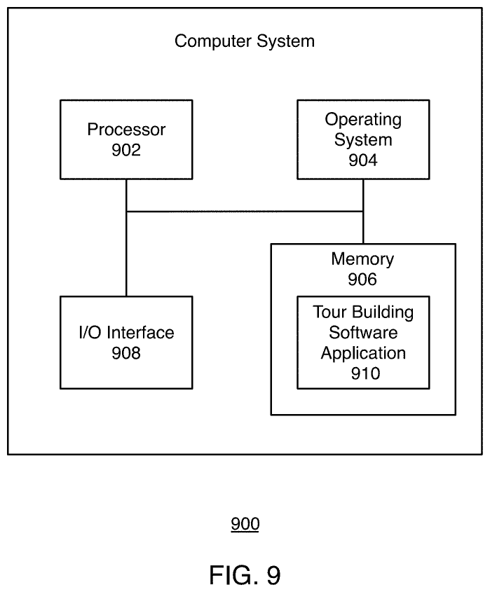

FIG. 9 is a block diagram of an example computer system 900, which may be used for some embodiments described herein. For example, computer system 900 may be used to implement system 102 of FIG. 1, as well as to perform embodiments described herein. In some implementations, computer system 900 may include a processor 902, an operating system 904, a memory 906, and an input/output (I/O) interface 908. In various implementations, processor 902 may be used to implement various functions and features described herein, as well as to perform the method implementations described herein. While processor 902 is described as performing implementations described herein, any suitable component or combination of components of computer system 900 or any suitable processor or processors associated with computer system 900 or any suitable system may perform the steps described. Implementations described herein may be carried out on a user device, on a server, or a combination of both.

Computer system 900 also includes a software application 910, or tour building software application, which may be stored in memory 906 or on any other suitable storage location or computer-readable medium. Software application 910 provides instructions that enable processor 902 to perform the implementations described herein and other functions. Software application may also include an engine such as a network engine for performing various functions associated with one or more networks and network communications. The components of computer system 900 may be implemented by one or more processors or any combination of hardware devices, as well as any combination of hardware, software, firmware, etc.

For ease of illustration, FIG. 9 shows one block for each of processor 902, operating system 904, memory 906, I/O interface 908, and software application 910. These blocks 902, 904, 906, 908, and 910 may represent multiple processors, operating systems, memories, I/O interfaces, and software applications. In various implementations, computer system 900 may not have all of the components shown and/or may have other elements including other types of components instead of, or in addition to, those shown herein.

Although the description has been described with respect to particular embodiments thereof, these particular embodiments are merely illustrative, and not restrictive. Concepts illustrated in the examples may be applied to other examples and implementations.

In various implementations, software is encoded in one or more non-transitory computer-readable media for execution by one or more processors. The software when executed by one or more processors is operable to perform the implementations described herein and other functions.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a non-transitory computer-readable storage medium (also referred to as a machine-readable storage medium) for use by or in connection with the instruction execution system, apparatus, or device. Particular embodiments can be implemented in the form of control logic in software or hardware or a combination of both. The control logic when executed by one or more processors is operable to perform the implementations described herein and other functions. For example, a tangible medium such as a hardware storage device can be used to store the control logic, which can include executable instructions.

Particular embodiments may be implemented by using a programmable general purpose digital computer, and/or by using application specific integrated circuits, programmable logic devices, field programmable gate arrays, optical, chemical, biological, quantum or nanoengineered systems, components and mechanisms. In general, the functions of particular embodiments can be achieved by any means as is known in the art. Distributed, networked systems, components, and/or circuits can be used. Communication, or transfer, of data may be wired, wireless, or by any other means.

A “processor” may include any suitable hardware and/or software system, mechanism, or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory. The memory may be any suitable data storage, memory and/or non-transitory computer-readable storage medium, including electronic storage devices such as random-access memory (RAM), read-only memory (ROM), magnetic storage device (hard disk drive or the like), flash, optical storage device (CD, DVD or the like), magnetic or optical disk, or other tangible media suitable for storing instructions (e.g., program or software instructions) for execution by the processor. For example, a tangible medium such as a hardware storage device can be used to store the control logic, which can include executable instructions. The instructions can also be contained in, and provided as, an electronic signal, for example in the form of software as a service (SaaS) delivered from a server (e.g., a distributed system and/or a cloud computing system).

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

What is claimed is:

1. A system comprising:
one or more processors; and
logic encoded in one or more non-transitory computer-readable media for execution by the one or more processors and when executed operable to cause the one or more processors to perform operations comprising:
generating one or more tour forming components, wherein the one or more tour forming components comprise one or more of a transportation component, an accommodation component, a catering component, a supply component, a sightseeing component, an activities component, a services component, and an events component; and
generating one or more itineraries for one or more travelers, wherein each itinerary of the one or more itineraries is based on at least the one or more tour forming components.

2. The system of claim 1, wherein the logic when executed is further operable to cause the one or more processors to perform operations comprising:
determining one or more tour forming component timelines based on at least the one or more travelers; and
modifying at least one of the tour forming component timelines based on one or more policies.

3. The system of claim 1, wherein the logic when executed is further operable to cause the one or more processors to perform operations comprising:
determining tour phases associated with each of the tour forming components;
determining transition time periods between the tour phases; and
modifying at least one of the transition time periods based on one or more policies.

4. The system of claim 1, wherein the logic when executed is further operable to cause the one or more processors to perform operations comprising:
determining one or more tour forming component cost values associated with the one or more tour forming components; and
modifying at least one of the tour forming component cost values based on one or more policies.

5. The system of claim 1, wherein the logic when executed is further operable to cause the one or more processors to perform operations comprising:
monitoring the one or more tour forming component timelines in real-time;
determining one or more policies associated with the one or more travelers; and
modifying the one or more tour forming component timelines in real-time based on the one or more policies.

6. A system comprising:
one or more processors; and
logic encoded in one or more non-transitory computer-readable media for execution by the one or more processors and when executed operable to cause the one or more processors to perform operations comprising:
generating one or more itineraries for one or more travelers, wherein each itinerary of the one or more itineraries is associated with one or more tour forming components;
determining one or more tour forming component timelines associated with the one or more tour forming components;
determining one or more master timelines based on at least the one or more tour forming component timelines;
modifying at least one master timeline of the one or more master timelines to provide at least one modified master timeline based on one or more policies, wherein at least one policy of the one or more policies is based on at least one characteristic of the one or more travelers; and
generating at least one modified itinerary for the one or more travelers, wherein the at least one modified itinerary is based on the at least one modified master timeline.

7. The system of claim 6, wherein the one or more travelers are associated with a group of travelers.

8. The system of claim 6, wherein the one or more travelers are individual travelers.

9. The system of claim 6, wherein the one or more travelers are subjects of one or more of a land operation, a domestic tour, an inbound tour, and an outbound tour.

10. The system of claim 6, wherein the one or more tour forming components are associated with local services at a destination location.

11. The system of claim 6, wherein the one or more tour forming components comprise one or more of a transportation component, an accommodation component, a catering component, a supply component, a sightseeing component, an activities component, a services component, and an events component.

12. The system of claim 6, wherein at least a second policy of the one or more policies is based on at least one characteristic of one or more of the tour forming components.

13. The system of claim 6, wherein the logic when executed is further operable to cause the one or more processors to perform operations comprising causing a user interface to display the one or more tour forming component timelines.

14. The system of claim 6, wherein the logic when executed is further operable to cause the one or more processors to perform operations comprising determining a tour forming component cost value associated with at least one tour forming component.

15. A non-transitory computer-readable storage medium with program instructions stored thereon, the program instructions when executed by one or more processors operable to cause the one or more processors to perform operations comprising:
generating one or more itineraries for one or more travelers, wherein each itinerary of the one or more itineraries is associated with one or more tour forming components;
determining one or more tour forming component timelines associated with the one or more tour forming components;
determining one or more master timelines based on at least the one or more tour forming component timelines;
modifying at least one master timeline of the one or more master timelines to provide at least one modified master timeline based on one or more policies, wherein at least one policy of the one or more policies is based on at least one characteristic of the one or more travelers; and
generating at least one modified itinerary for the one or more travelers, wherein the at least one modified itinerary is based on the at least one modified master timeline.

16. The computer-readable storage medium of claim 15, wherein the one or more travelers are associated with a group of travelers.

17. The computer-readable storage medium of claim 15, wherein the one or more travelers are individual travelers.

18. The computer-readable storage medium of claim 15, wherein the one or more travelers are subjects of one or more of a land operation, a domestic tour, an inbound tour, and an outbound tour.

19. The computer-readable storage medium of claim 15, wherein the one or more tour forming components are associated with local services at a destination location.

20. The computer-readable storage medium of claim 15, wherein the one or more tour forming components comprise one or more of a transportation component, an accommodation component, a catering component, a supply component, a sightseeing component, an activities component, a services component, and an events component.
